(19) United States
(12) Patent Application Publication
(10) Pub. No.: US 2003/0112982 A1
(43) Pub. Date: Jun. 19, 2003

(54) Apparatus and method for controlling audio noise attenuation by monitoring buffer

(76) Inventors: Kyung Hee Lee, Taejon (KR); Dong Myung Sul, Taejon (KR); Sung Ho Ahn, Taejon (KR); Ji Young Kwak, Kwangju (KR); Doo Hyun Kim, Taejon (KR)

Correspondence Address: JACOBSON HOLMAN & STERN, PROFESSIONAL LIMITED LIABILITY COMPANY, 400 SEVENTH STREET, N. W., WASHINGTON, DC, 20004, US

(21) Appl. No.: 10/066,732

(22) Filed: Feb. 6, 2002

(30) Foreign Application Priority Data
Dec. 18, 2001 (KR) 2001-80718

(51) Int. Cl. H04B 15/00

(52) U.S. Cl. 381/94.1; 381/94.5; 381/123

(57) ABSTRACT

An apparatus and method for controlling the audio noise attenuation by monitoring a buffer are disclosed. If the audio data to be reproduced, and if the user sets the operation as an automatic mode so that the operation of controlling the audio noise attenuation by monitoring the buffer is automatically executed, the operation of the loudspeaker is interrupted. In addition, if the audio data to be reproduced is stored, the loudspeaker is continuously driven regardless of the set of the mode. Furthermore, if there is no the audio data to be reproduced, and if the operation is not set as the automatic mode, the loudspeaker is operated. Accordingly, the analog noise, which may be generated when silence is outputted from the loudspeaker, can be eliminated, thereby improving the quality of the conference and the audio reproducing quality.

### BACKGROUND OF THE INVENTION

1. Field of the Invention

The present invention relates to an apparatus and method for controlling audio noise attenuation by monitoring a buffer, and more particularly, to an apparatus and method for controlling audio noise attenuation by monitoring a buffer, in which when digital audio data is converted to an analog signal to be outputted to a loudspeaker, an analog noise, which may be generated when silence is outputted from the loudspeaker if there is no the audio data, is eliminated by interrupting a circuit of the loudspeaker.

2. Background of the Related Art

Generally, the propagation of personal computers causes voice communication over the Internet protocol to be spread. In order to process voice or sound signals, digital systems such as a personal computer employ a method of storing and transferring digital audio data. In such a digital system, silence detection may be used to reduce a transferring amount of the audio data.

In an application such as a real time conversation, if it is determined that the audio data is silence, the transferring amount of the audio data may be reduced by interrupting the transfer of the audio data. At that time, after the personal computer of a companion receives the digital audio data, the computer converts the received digital audio data to the analog signal, and amplifies and outputs it through a loudspeaker.

In the most of the above conversation, when a person speeches, the other persons are in a mode of listening to him or her. At that time, the system of the listener acquires a digital audio sample through an audio input unit, and transfers it to the companion. When the listener does not speech, if silence data is not transferred rather than the data is transferred and outputted, a load of a communication network may be reduced.

A typical audio data output apparatus will now be explained in brief with reference to FIG. 1.

As shown in FIG. 1, the apparatus comprises an audio data storing unit 10 for storing audio data, a D/A converter 20 for converting the audio data stored in the audio data storing unit 10 to an analog signal, and an audio output unit 30 for amplifying and outputting the audio signal converted by the D/A converter. The audio data storing unit 10 consists of a plurality of buffers, and the audio output unit 30 may be a loudspeaker.

The audio data stored in the audio data storing unit 10 is converted to the analog audio signal by the D/A converter 20, and is amplified and outputted through the audio output unit 30. At that time, the adjustment of an output volume of the loudspeaker and the interruption of an output circuit of the loudspeaker are achieved by a user using the loudspeaker.

Even though the data buffer of the audio data storing unit 10 is empted in course of the audio output, the D/A converter 20 still operates. If the output of the D/A converter is connected to the audio output unit 30, there must be an actual output signal. However, upon constructing and operating the analog circuit, imperceptible signal is amplified as a noise, and the noise signal is outputted through the loudspeaker 30.

Accordingly, if the audio data is no in the audio data storing unit 10, in order to attenuating the noise, it uses a mode of basically suppressing the generation of the analog noise signal, or a mode of optionally regulating the output of the loudspeaker by a user operating the loudspeaker.

After all, upon outputting the existing digital audio data, the signal outputted through the D/A converter is outputted to the loudspeaker. Under the condition that there is no digital data, if the operation of the loudspeaker is interrupted by the will of the user, the output circuit of the loudspeaker is continuously driven. The loudspeaker amplifies and outputs the output of the D/A converter. Even though there is no input signal to be actually outputted, electrically imperceptible noise is in the loudspeaker and the circuit inputted to the loudspeaker. At that time, the loudspeaker is operated, there is a problem that the noise signal is amplified and outputted through the loudspeaker.

### SUMMARY OF THE INVENTION

Accordingly, the present invention is directed to an apparatus and method for controlling audio noise attenuation by monitoring a buffer that substantially obviates one or more problems due to limitations and disadvantages of the related art.

An object of the present invention is to provide an apparatus and method for controlling audio noise attenuation by monitoring a buffer, in which when digital audio data is converted to an analog signal to be outputted to a loudspeaker, an analog noise, which may be generated when silence is outputted from the loudspeaker if there is no the audio data, is eliminated by interrupting an output circuit of the loudspeaker. In other words, the object of the present invention is to attenuate the noise by automatically interrupting the operation of the output circuit of the loudspeaker, if there is no the audio data to be outputted. In addition, under the condition that the output circuit of the loudspeaker is not operated by the interruption, if the audio data to be outputted is inputted, the output circuit of the loudspeaker is driven to reproduce the audio data.

To achieve the object and other advantages, according to one aspect of the present invention, there is provided an apparatus for controlling audio noise attenuation by monitoring a buffer, the apparatus including a loudspeaker reproducing an audio signal, the apparatus comprising: audio data storing means for storing audio data to be reproduced; D/A converting means for converting the audio data stored in the storing means to an analog signal; switching means for switching connection between the D/A converting means and the loudspeaker according to a switching control signal; time setting means for setting a time until the audio data stored in the storing means is completely outputted and outputting a timer flag signal according to variation of the set time; and output control means for outputting a switching control signal to the switching means according to a timer flag signal outputted from the time setting means and a user flag signal set by a user. The switching means is at least one selected from a plurality of switching elements, a multiplexer, and a demultiplexer.

The time setting means generates the timer flag signal if the audio data to be outputted is in the storing means, and does not generate the timer flag signal if no the audio data to be outputted is in the storing means.

The switching means a) operates the loudspeaker by outputting the switching control signal to the switching means to connect the D/A converting means and the loudspeaker, if the user flag is not set, and b) operates the loudspeaker by outputting the switching control signal to the switching means, if the timer flag signal is generated and the user flag is set.

The storing unit comprises a plurality of data buffers which are identical in sizes thereof, each of the data buffers storing the audio data having a same size as the others; a head pointer indicating one of the data buffers which stores the oldest data, and outputting the audio data stored in the corresponding buffer to the D/A converting means; and a tail pointer indicating one of the data buffers which stores the latest data.

The time setting means comprises a real time clock generating unit for generating a clock every a certain period; an initial set time value storing unit for storing a time value until all of the audio data stored in one of the data buffers of the storing means is transferred to the D/A converting means; an effective time storing unit for a) calling an initial time value stored in the initial set time value storing unit and storing the called time as an effective time value, and b) periodically calling the stored effective time value according to the period of the clock generated in the real time clock generating unit, and if the stored value is more than 0, subtracting a time corresponding to a called period, and outputting a flag control signal; and a timer flag generating unit for generating unit for generating a timer flag signal according to the flag generating control signal outputted from the effective time value storing unit.

The switching control means comprises an AND gate for operating the timer flag signal outputted from the timer flag generating means of the time setting means and a user flag signal provided from a user; an inverter for inverting the user flag signal set by the user; and an OR gate for operating a signal inputted from the inverter and a signal inputted from the AND gate to output the resultant value to the switching means.

According to another aspect of the present invention, there is provided a method for controlling audio noise attenuation by monitoring a buffer, the method comprising the steps of: sequentially storing inputted audio data in same size thereof in plurality of data buffers each having a same size as the others; sequentially converting the audio data stored in each data buffer to an analog signal; setting a timer whenever the audio data stored in each buffer is outputted, periodically reducing a time value stored in the timer by a time period according to a real time clock provided by the set timer, and generating a timer flag signal according to a time of the reduced timer; and controlling operation of a loudspeaker according to the generated timer flag signal and a user flag signal set by a user.

The step of generating the timer flag signal generates the timer flag signal, if a residual time of the timer is above “0”, and no generates the timer flag signal if the residual time of the timer is below “0”.

The step of controlling operation of the loudspeaker comprises the steps of: OR operating the timer flag signal and the user flag signal set by the user; Inverting the user flag signal set by the user and outputting the inverted signal; and AND operating the inverted signal of the user flag signal and the OR operated signal, and controlling the operation of the loudspeaker according to the resultant value.

The step of controlling operation of the loudspeaker comprises the steps of: determining whether the user flag is set by the user and the timer flag signal is generated; operating the loudspeaker, if the user flag is not set, or if the user flag is not set and the timer flag signal is generated; and interrupting the loudspeaker, if the user flag is set, and the timer flag signal is not generated.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a typical audio data output apparatus;

FIG. 2 is a block diagram of an apparatus for controlling audio noise attenuation by monitoring a buffer according to one preferred embodiment of the present invention;

FIG. 3 is a block diagram of the audio data storing unit in FIG. 2;

FIG. 4 is a block diagram of the time setting unit in FIG. 2;

FIG. 5 is a block diagram of the output control unit in FIG. 2; and

FIG. 6 is a flowchart of the process of the output control unit in FIG. 5.

### DETAILED DESCRIPTION OF THE PREFERRED EMBODIMENTS

The apparatus and method for controlling audio noise attenuation by monitoring a buffer according to one preferred embodiment of the present invention will now be explained with reference to the accompanying drawings.

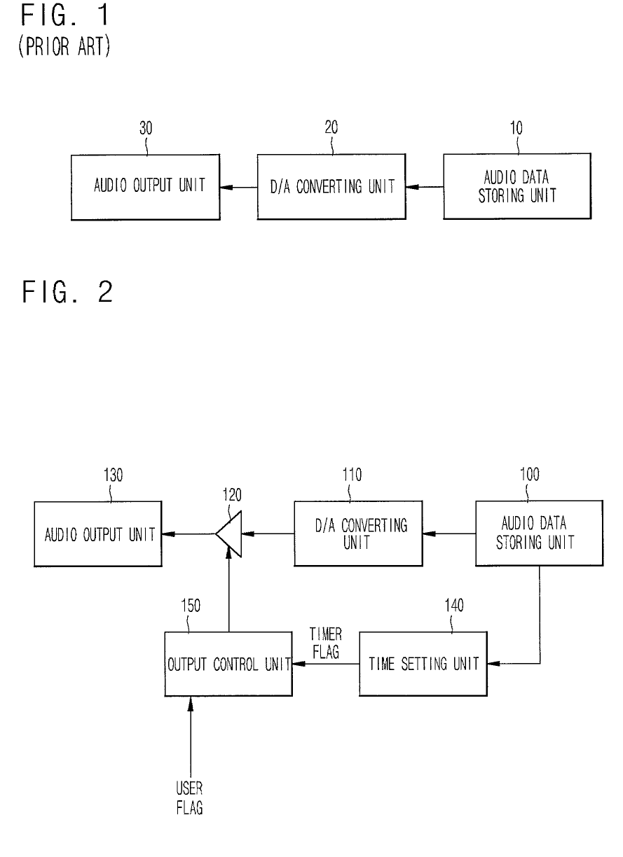

FIG. 2 is a block diagram of an apparatus for controlling audio noise attenuation by monitoring a buffer according to one preferred embodiment of the present invention. Referring to FIG. 2, the apparatus of the present invention comprises an audio data storing unit 100, a D/A converter 110, a switching unit 120, an audio output unit 130, a time setting unit 140, and an output control unit 150.

The audio data storing unit 100 includes a plurality of data buffers to store digital audio data to be converted from a digital signal to an analog signal by the D/A converting unit 110. Unit data stored in the audio data storing unit 100 has a same size as the others.

The D/A converter 110 converts the digital audio data outputted from the audio data storing unit 100 to the analog audio signal, and outputs the converted analog audio signal to the audio output unit 130 via the switching unit 120.

The audio output unit 130 amplifies and outputs the analog audio signal outputted from the switching unit 120 so that a user can listen the analog audio signal. The audio output unit is a loudspeaker, and may comprise an amplifier for amplifying the analog signal at a certain level. The amplifier may be built in the D/A converter 110.

The switching unit 120 functions as a connector between the D/A converter 110 and the audio output unit 130 in response to a switching control signal supplied from the output control unit 150. For example, if the output control unit 150 outputs a switching signal to the switching unit 120, the switching unit 120 connects the D/A converter 110 to the audio output unit 130, thereby outputting the analog audio signal converted by the D/A converter 110 to the audio output unit 130, while if the switching control signal is no provided from the output control unit 150, the switching unit 120 interrupts the connection between the D/A converter 110 and the audio output unit 130. On the contrary, if the switching control signal is provided from the output control unit 150, the switching unit 120 interrupts the connection between the D/A converter 110 and the audio output unit 130, while if the switching control signal is no provided from the output control unit 150, the switching unit 120 connects the D/A converter 110 to the audio output unit 130 to output a normal audio signal. The switching unit 120 is at least one selected from a plurality of switching elements, a multiplexer, and a demultiplexer.

The time setting unit 140 provides the output control unit 150 with a flag signal indicative of whether or not the audio data storing unit 100 outputs data to the D/A converting unit 110. Specifically, prior to the initial operation, each audio data stored in the audio data storing unit 100 is converted to the analog signal, and the time (effective setting time) until the audio data is completely outputted through the audio output unit 130 is set. And then, whenever the audio data stored in the audio data storing unit 100 begins to be transferred to the D/A converting unit 110, a value of a timer is set as the effective set time.

If the effective set time is decreased every unit time, and then a value of the set time comes to below “zero”, the output of the flag signal to the output control unit 150 is completed. After that, if the data transfer from the audio data storing unit 100 to the D/A converting unit 110 is restarted, the flag signal is outputted to the output control unit 150 through the process described above.

Summarizing the operation of each block, a format of the data to be outputted to the D/A converter 110 is set, and a time when one buffer block in the audio data storing unit 100 is outputted is set in the time setting unit 140.

If the data begins to be transferred to the audio data storing unit 100, the data is sequentially transferred to the D/A converter 110, and the time value of the time setting unit 140 is reset every transferring start time.

If the time value set in the time setting unit 140 is lapsed, the generation of the flag signal to the output control unit 150 is interrupted. If the generation of the flag signal is interrupted and a use flag of the output control unit 150 is set, in other words, where the user sets the operation of the output control unit 150 as turn-off, the output control unit 150 interrupts the transfer of the switching control signal to the switching unit 120, thereby interrupting the connection between the audio output unit 130 and the D/A converting unit 110. Accordingly, no any signal is outputted to the audio output unit 130. After all, if no data is stored in the audio data storing unit 100, an analog noise, which may be produced when silence is outputted, is eliminated by interrupting the connection of the loudspeaker 130.

Each block of the apparatus for controlling audio noise attenuation by monitoring a buffer according to one preferred embodiment of the present invention will be now explained in detail.

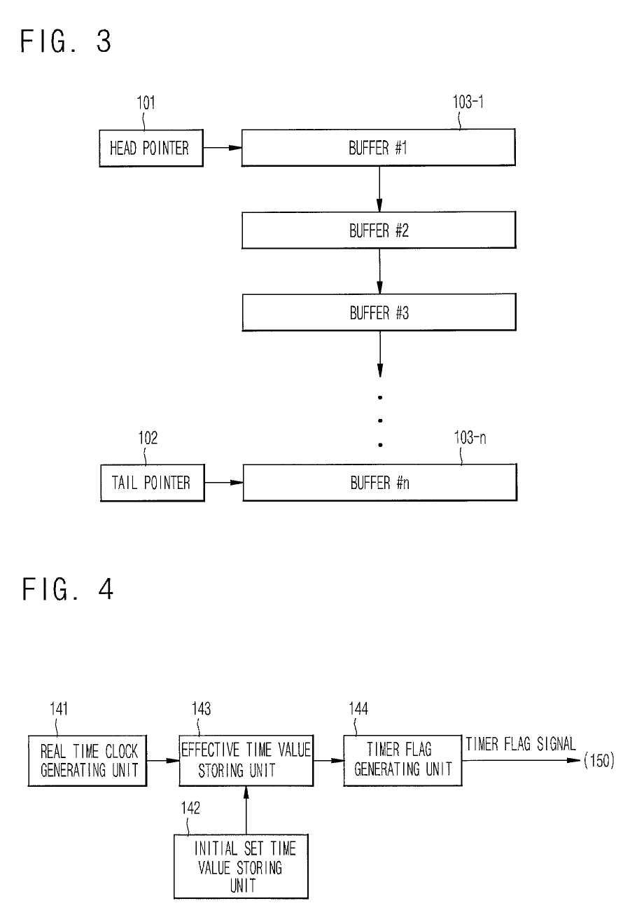

FIG. 3 is a block diagram of the audio data storing unit in FIG. 2.

As shown in FIG. 3, the audio data storing unit comprises a plurality of data buffers 103-1 to 103-n for storing input digital audio data, a head pointer 101, and a tail pointer 102.

Each of the plurality of data buffers 103-1 to 103-n has a same size, and stores a same size of audio data.

The head pointer 101 indicates one of the data buffers 103-1 to 103-n which stores the oldest data, while the tail pointer 102 indicates one of the data buffers 103-1 to 103-n which stores the latest data.

In the early stage, the head pointer 101 and the tail pointer 102 are to have a null value. When the data buffer is transferred, if the head pointer 101 is null, both the head pointer 101 and the tail pointer 102 are to indicate the data buffer. After that, the data is transferred, the tail pointer 102 indicates lately transferred data buffer.

After all, the transfer of the audio data from the audio data storing unit 100 to the D/A converter 110 firstly provides the audio data stored in the data buffer indicated by the header pointer 101. If the providing of the data is completed, a next data buffer to be transferred is indicated automatically.

If all of the data stored in the data buffer is transferred to the D/A converter 110, and no further data is transferred to the D/A converter, the header pointer 101 is substituted for the null value. At that time, whenever the audio data stored in each data buffer is transferred to the D/A converter 110, the time set value which is set in the time setting unit 140 is set.

FIG. 4 is a block diagram of the time setting unit in FIG. 2, in which the time setting unit comprises a real time clock generating unit 141, an effective time value storing unit 143, an initial set time value storing unit 142, and a timer flag generating unit 144.

The real time clock generating unit 141 periodically calls an effective time value storing unit 143 in which the effective time values are stored, and if the stored value is more than 0, subtracts a time corresponding to a called period.

The effective time value storing unit 143 calls and stores the initial time value stored in the initial set time value storing unit 142, and provides a flag generating control signal to the timer flag generating unit 144 according to a called event information. Accordingly, the timer flag generating unit 144 generates and provides a timer flag signal to the output control unit 150.

On the initial operation, the time until the transfer of all of audio data to the D/A converter 110, which is stored in one of the data buffers 103-1 to 103-n of the audio data storing unit 100, is completed, is designated and stored in the initial set time value storing unit 142.

If a signal is periodically transferred to the effective time value storing unit 143 from the real time clock generating unit 141, the effective time value storing unit 143 subtracts the stored time data corresponding to a period time.

If the time information stored in the effective time value storing unit 143 is less than 0, the generation of the timer flag signal by the timer flag generating unit 144 is interrupted.

If the time information stored in the effective time value storing unit 143 is more than 0, however, the timer flag generating unit 144 continuously generates the timer flag signal to output it to the output control unit 150.

In addition, if the audio data stored in other data buffer of the audio data storing unit 100 is outputted to the D/A converter 110, the value of the initial set time value storing unit 142 is again stored in the effective time value storing unit 143, and the generation and interruption of the timer flag signal are executed through the process described above.

Meanwhile, the output control unit 150 shown in FIG. 2 will now be explained in detail with reference to 5.

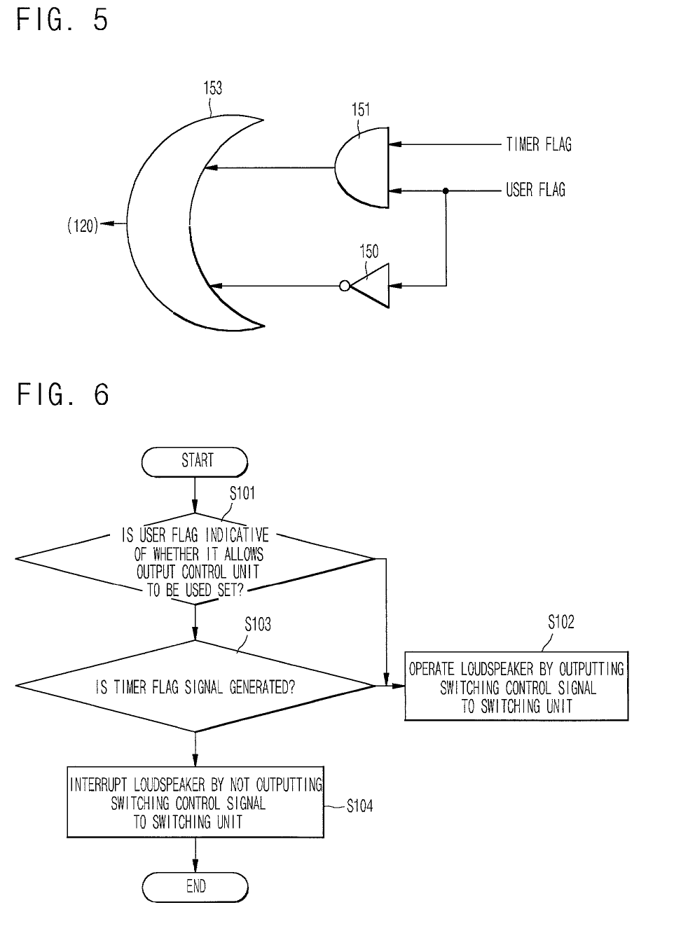

FIG. 5 is a block diagram of the output control unit in FIG. 2.

As will be seen from FIG. 5, the output control unit 150 comprises an AND gate 151 for operating the timer flag signal outputted from the timer flag generating unit 144 of the time setting unit 140 and a user flag signal provided from a user, an inverter 152 for inverting the user flag signal provided from the user, and an OR gate 153 for operating a signal inputted from the inverter 152 and a signal inputted from the AND gate 151 to output the resultant value to the switching unit 120.

Specifically, if the timer flag generating unit 144 of the time setting unit 140 generates the timer flag signal and the timer flag value “1” is inputted (when there is data to be outputted to the audio data storing unit 100), and if the user flag signal “1” in which the user sets the usage of the output control unit 150 is inputted (when setting the usage of the output control unit), the AND gate 151 operates two signals, and outputs “1” to the input of the OR gate. At that time, if the user flag signal “1” is inputted, since the value is inverted by the inverter 152, the value “0” is inputted to other input of the OR gate 153. Accordingly, the output signal of the OR gate 153 becomes “1”, thereby switching the switching unit 120 and driving the loudspeaker 130.

Meanwhile, if the timer flag generating unit 144 of the time setting unit 140 generates the timer flag signal and the timer flag value “1” is inputted (when there is data to be outputted to the audio data storing unit 100), and if the user flag signal “0” in which the user sets the usage of the output control unit 150 is inputted (when no setting the usage of the output control unit), the AND gate 151 operates two signals, and outputs “0” to the input of the OR gate. At that time, if the user flag signal “0” is inputted, since the value is inverted by the inverter 152, the value “1” is inputted to other input of the OR gate 153. Accordingly, the output signal of the OR gate 153 becomes “1”, thereby switching the switching unit 120 and driving the loudspeaker 130. In this case, although the user dose not set the usage of the output control unit 150, it means there is the audio data to be outputted to the audio data storing unit 100.

Furthermore, if no the timer flag generating unit 144 of the time setting unit 140 generates the timer flag signal, in other words, when there is no data to be outputted to the audio data storing unit 100, the output value of the timer flag generating unit 144 becomes “0”. If the user flag signal “1” in which the user sets the usage of the output control unit 150 is inputted, the AND gate 151 operates two signals, and outputs “0” to the input of the OR gate. At that time, if the user flag signal “1” is inputted, since the value is inverted by the inverter 152, the value “0” is inputted to other input of the OR gate 153. Accordingly, the output signal of the OR gate 153 becomes “0”, thereby no switching the switching unit 120 and interrupting the operation of the loudspeaker 130.

Finally, if no the timer flag generating unit 144 of the time setting unit 140 generates the timer flag signal, in other words, when there is no data to be outputted to the audio data storing unit 100, the output value of the timer flag generating unit 144 becomes “0”. If the user flag signal “0” in which the user sets the usage of the output control unit 150 is inputted, the AND gate 151 operates two signals, and outputs “0” to the input of the OR gate. At that time, if the user flag signal “0” is inputted, since the value is inverted by the inverter 152, the value “1” is inputted to other input of the OR gate 153. Accordingly, the output signal of the OR gate 153 becomes “1”, thereby switching the switching unit 120 and driving the loudspeaker 130. In this case, even if there is no the audio data outputted to the audio data storing unit 100, when no the user sets the usage of the output control unit 150, the loudspeaker is driven.

In brief, if the user flag indicative of whether the output control unit 150 is used is not set, the output control unit 150 outputs the switching control signal to the switching unit 120 to drive the loudspeaker 130. If the audio data to be outputted to the audio data storing unit 100, the timer flag signal is generated. If the user flag is set, the output control unit 150 outputs the switching control signal to the switching unit 120 to drive the loudspeaker 130. In other case, no the output control unit 150 outputs the switching control signal to the switching unit 120 to interrupt the operation of the loudspeaker 130.

The process explained above is shown by a table 1 as follows:

TABLE 1

| | | | | | Switching operation |
|---|---|---|---|---|---|
| | | | | | (operation of |
| Timer flag | User flag | AND | Inverter | OR | loudspeaker) |
| 0 | 0 | 0 | 1 | 1 | O |
| 0 | 1 | 0 | 0 | 0 | x |
| 1 | 0 | 0 | 1 | 1 | O |
| 1 | 1 | 1 | 0 | 1 | O |

The operating process of the output control unit 150 shown in FIG. 5 will be now explained with reference to FIG. 6.

FIG. 6 is a flowchart of the process of the output control unit in FIG. 5.

Firstly, it is determined whether or not the user sets the user flag indicative of that it may use the output control unit 150 (step S101).

As a result, if the user flag is not set, the output control unit 150 outputs the switching control signal to the switching unit 120 to connect the D/A converter 110 and the loudspeaker 130, thereby driving the loudspeaker 130 (step S102).

If the user flag is set in the step S101, however, it is determined whether the timer flag signal is generated in the time setting unit 140 shown in FIG. 1 (step S103). The time flag signal is generated in case that there is the audio data to be outputted to the audio data storing unit 100.

As a result, since the audio data to be outputted to the audio data storing unit 100 is in the time setting unit 140, if the time flag signal is generated, the output control unit 150 outputs the switching control signal to the switching unit 120 to connect the D/A converter 110 and the loudspeaker 130, thereby driving the loudspeaker 130, as shown in FIG. 1 (step S102).

If the timer flag signal is generated in the step S103, however, no the output control unit 150 outputs the switching control signal to the switching unit 120, thereby interrupting the connection between the D/A converter 110 and the loudspeaker 130 and thus stopping the operation of the loudspeaker 130.

After all, with the apparatus and method for controlling the audio noise attenuation by monitoring the buffer according to the present invention, if the audio data to be reproduced, and if the user sets the operation as an automatic mode so that the operation of controlling the audio noise attenuation by monitoring the buffer is automatically executed, the operation of the loudspeaker is interrupted.

In addition, if the audio data to be reproduced is stored, the loudspeaker is continuously driven regardless of the set of the mode. Furthermore, if there is no the audio data to be reproduced, and if the operation is not set as the automatic mode, the loudspeaker is operated. Accordingly, the analog noise, which may be generated when silence is outputted from the loudspeaker, can be eliminated, thereby improving the quality of the conversation and the audio reproducing quality.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for controlling audio noise attenuation by monitoring a buffer, the apparatus including a loudspeaker reproducing an audio signal, the apparatus comprising:
audio data storing means for storing audio data to be reproduced;
D/A converting means for converting the audio data stored in the storing means to an analog signal;
switching means for switching connection between the D/A converting means and the loudspeaker according to a switching control signal;
time setting means for setting a time until the audio data stored in the storing means is completely outputted and outputting a timer flag signal according to variation of the set time; and
output control means for outputting a switching control signal to the switching means according to a timer flag signal outputted from the time setting means and a user flag signal set by a user.

2. The apparatus as claimed in claim 1, wherein the switching means is at least one selected from a plurality of switching elements, a multiplexer, and a demultiplexer.

3. The apparatus as claimed in claim 1, wherein the time setting means generates the timer flag signal if the audio data to be outputted is in the storing means, and does not generate the timer flag signal if no the audio data to be outputted is in the storing means.

4. The apparatus as claimed in claim 1, wherein the switching means a) operates the loudspeaker by outputting the switching control signal to the switching means to connect the D/A converting means and the loudspeaker, if the user flag is not set, and b) operates the loudspeaker by outputting the switching control signal to the switching means, if the timer flag signal is generated and the user flag is set.

5. The apparatus as claimed in claim 1, wherein the storing unit comprises:
a plurality of data buffers which are identical in sizes thereof, each of the data buffers storing the audio data having a same size as the others;
a head pointer indicating one of the data buffers which stores the oldest data, and outputting the audio data stored in the corresponding buffer to the D/A converting means; and
a tail pointer indicating one of the data buffers which stores the latest data.

6. The apparatus as claimed in claim 1, wherein the time setting means comprises:
a real time clock generating unit for generating a clock every a certain period;
an initial set time value storing unit for storing a time value until all of the audio data stored in one of the data buffers of the storing means is transferred to the D/A converting means;
an effective time storing unit for a) calling an initial time value stored in the initial set time value storing unit and storing the called time as an effective time value, and b) periodically calling the stored effective time value according to the period of the clock generated in the real time clock generating unit, and if the stored value is more than 0, subtracting a time corresponding to a called period, and outputting a flag control signal; and
a timer flag generating unit for generating unit for generating a timer flag signal according to the flag generating control signal outputted from the effective time value storing unit.

7. The apparatus as claimed in claim 1, wherein the switching control means comprises:
an AND gate for operating the timer flag signal outputted from the timer flag generating means of the time setting means and a user flag signal provided from a user;
an inverter for inverting the user flag signal set by the user; and
an OR gate for operating a signal inputted from the inverter and a signal inputted from the AND gate to output the resultant value to the switching means.

8. A method for controlling audio noise attenuation by monitoring a buffer, the method comprising the steps of:
sequentially storing inputted audio data in same size thereof in plurality of data buffers each having a same size as the others;
sequentially converting the audio data stored in each data buffer to an analog signal;
setting a timer whenever the audio data stored in each buffer is outputted, periodically reducing a time value stored in the timer by a time period according to a real time clock provided by the set timer, and generating a timer flag signal according to a time of the reduced timer; and
controlling operation of a loudspeaker according to the generated timer flag signal and a user flag signal set by a user.

9. The method as claimed in claim 8, wherein the step of generating the timer flag signal generates the timer flag signal, if a residual time of the timer is above “0”, and no generates the timer flag signal if the residual time of the timer is below “0”.

10. The method as claimed in claim 8, wherein the step of controlling operation of the loudspeaker comprises the steps of:
OR operating the timer flag signal and the user flag signal set by the user;
Inverting the user flag signal set by the user and outputting the inverted signal; and
AND operating the inverted signal of the user flag signal and the OR operated signal, and controlling the operation of the loudspeaker according to the resultant value.

11. The method as claimed in claim 8, wherein the step of controlling operation of the loudspeaker comprises the steps of:
determining whether the user flag is set by the user and the timer flag signal is generated;
operating the loudspeaker, if the user flag is not set, or if the user flag is not set and the timer flag signal is generated; and
interrupting the loudspeaker, if the user flag is set, and the timer flag signal is not generated.
